(19) United States
(12) Patent Application Publication
(10) Pub. No.: US 2009/0070143 A1
(43) Pub. Date: Mar. 12, 2009

(54) Method and system for differential diagnosis neuro solution

(76) Inventor: Sultan Haider, Erlangen (DE)

Correspondence Address: BRINKS HOFER GILSON & LIONE, P.O. BOX 10395, CHICAGO, IL, 60610, US

(21) Appl. No.: 11/978,744

(22) Filed: Oct. 29, 2007

Related U.S. Application Data
(60) Provisional application No. 60/993,135, filed on Sep. 10, 2007.

(51) Int. Cl. G06Q 50/00

(52) U.S. Cl. 705/3; 705/2

(57) ABSTRACT

A system and method for diagnosing neurological syndromes is described. A form-based data entry device is used to collect data about the current state of the patient, and the data is supplemented by such data as may be available for a patient history medical data base. A rule-based analysis engine is used to process the data so as to produce a diagnosis of one of ischemic stroke, hemorrhagic stroke, or other non-stroke syndrome, and a suitable care path recommended. The rule-based engine may be modified to reflect the capabilities and diagnostic equipment suite available at a specific medical facility, and to implement a version of an approved medical protocol consistent with the local constraints. The diagnosis is linkable to a suitable care path plan. Some of all of the form-based data may be entered by emergency personnel while the patient is in transit to the treatment facility.

This application claims the benefit of U.S. Provisional application Ser. No. 60/993,135, filed on Sep. 10, 2007, which is incorporated herein by reference.

### TECHNICAL FIELD

The present application relates to a method and system of improving patient care by assisting in the diagnosis of neurological syndromes.

### BACKGROUND

Stroke is the third-leading cause of death in the United States, behind heart disease and cancer, killing 150,000 people a year, and leaving many more permanently disabled. The annual cost is about $62.7 billion in direct and indirect costs, according to the American Stroke Association.

Many patients with stroke symptoms are examined by emergency room doctors who have difficulty deciding whether the patient is actually having a stroke, a blockage or rupture of a blood vessel in the brain that injures or kills brain cells, or is suffering from another condition, some of which present with a similar constellation of symptoms. Doctors are therefore often reluctant to give the only drug shown to make a real difference, tPA, or tissue plasminogen activator.

Not all hospitals can afford to have neurologists on call to diagnose strokes, or afford to have magnetic resonance imaging (MRI) scanners, the currently most accurate instrument to assist in diagnosing strokes, for the emergency room. Although tPA was shown in 1996 to save lives and prevent brain damage, and although the drug could help about half of all stroke patients, currently only about 3 percent to 4 percent of the patients receive this treatment. Patients may wait too long to seek help, or the diagnosis may take too long as, at present, tPA must be administered within three hours of the stroke onset.

About a quarter of emergency room patients with symptoms suggestive of a stroke are not actually having one. There is also an outcome penalty for administering tPA to a patient who is not having an ischemic stroke. The patient may be suffering from a hemorrhagic stroke, for example, and the treatment may exacerbate the situation. Few emergency room doctors want to take that chance.

A diffusion MRI, a type of scan that shows water moving in the brain, is known to be more sensitive and more accurate than computed tomography (CT) scans, however many hospitals are presently unable, for economic or logistical reasons, to provide a MRI machine near the emergency room, and to staff the machine around the clock, or to displace patients already scheduled for the machine.

Thus, while particular diagnostic procedures are known, they are not equally available at each medical facility, and any procedure for diagnosing stroke needs to be adapted to the availability of equipment and personnel, while taking into account accepted diagnostic procedures and treatment norms.

### BRIEF SUMMARY

A method of diagnosing a neurological syndrome of a patient is disclosed, the method including providing a plurality of computer-displayable data forms, at least one of which provides for a selection of multiple responses to each of a plurality of pre-determined questions. A link to a data base of the patient historical data may be provided and data that is available for the patient is retrieved. Data may requested from the patient history, or data therefrom that is relevant to the present situation may be spontaneously displayed. A rule-based engine processes responses entered on the forms, and may also process data from the data base, so as to provide at least a preliminary diagnosis of the syndrome and a recommended care path. The rule-based engine may be adapted to conform to the existing diagnostic procedures and capabilities at a local medical facility.

In another aspect, a data processing system diagnosing neurological syndromes is described, the system including a data processor. The data processor is operable to maintain a form-based data entry system, and a rule-based process for processing data entered on the forms or retrieved from a patient medical history data base. Data may be accepted from at least one of the form-based data entry system or the patient medical history data. The data may be processed and using a rule-based engine to determine a diagnosis, where the diagnosis may be one of: ischemic stroke, hemorrhagic stroke, or other syndrome, where the other syndrome is not associated with stroke. The rule-based engine may be adapted to conform to the diagnostic procedures and decision criteria of a local medical facility.

In yet another aspect, a computer-readable medium having instructions executable on a computer stored thereon is described. The instructions cause a computer system to store and maintain a from-based data entry procedure, and to access at least one of a patient historical data base, and a care plan protocol. Data input to the form is accepted and patient historical data may be retrieved. The data is processed using a rule-based engine and a diagnosis consistent with the data is computed. The rule-based engine may be adapted to conform to the diagnostic procedures and decision criteria of a local medical facility.

### BRIEF DESCRIPTION OF THE DRAWINGS

FIG. 1 illustrates a system architecture for performing the method of differential diagnosis neuro solution;

FIG. 2 is an example of a top level questionnaire form, where the dizziness questionnaire is displayed;

FIG. 3 is an example of a questionnaire form for drugs being taken by a patient;

FIG. 4 is an example of a questionnaire form for related symptoms;

FIG. 5 is an example of a questionnaire form for previous diseases; and,

FIG. 6 is an output form with a suggested diagnosis and referral.

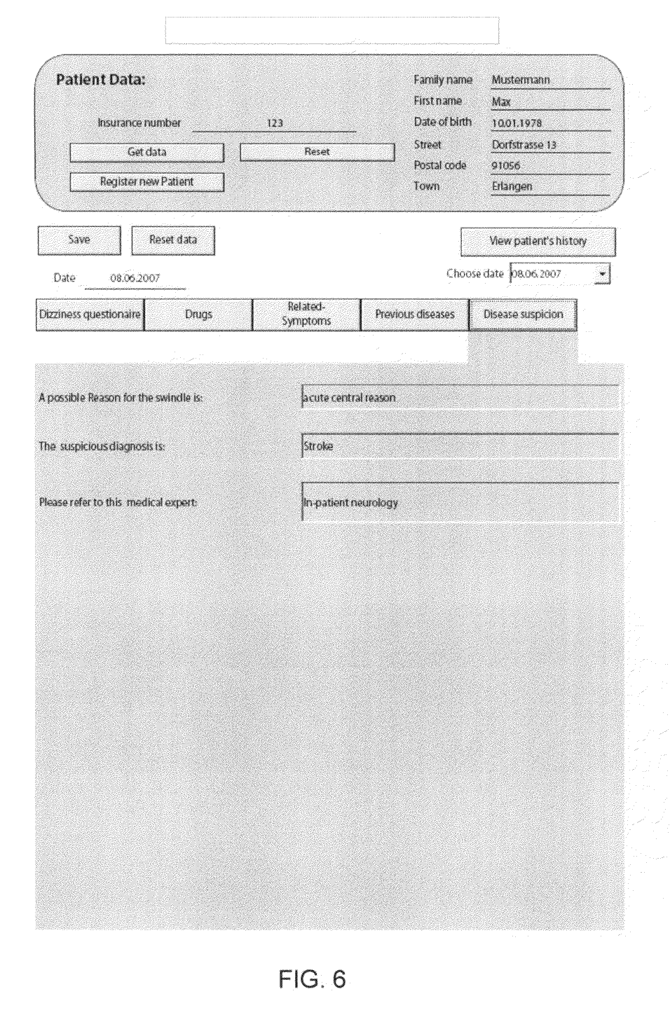

### DETAILED DESCRIPTION

Reference will now be made in detail to embodiments. While the invention will be described in conjunction with these embodiments, it will be understood that it is not intended to limit the invention to such embodiments. In the following description, numerous specific details are set forth in order to provide a thorough understanding of the present invention which, however, may be practiced without some or all of these specific details. In other instances, well known process operations have not been described in detail in order not to unnecessarily obscure the description.

The embodiments described herein include methods, processes, apparatuses, instructions, systems, or business concepts for diagnosing patients presenting with one or more symptoms which may be indicative of a stroke. However, the examples of diseases, syndromes, conditions, and the like, and the types of examination, diagnosis and treatment protocols described herein are by way of example, and are not meant to suggest that the method and system is limited to those named, or the equivalents thereof. As the medical arts are continually advancing, the use of the methods and system described herein may be expected to encompass a broader scope in optimizing the diagnosis and treatment of patients.

The combination of hardware and software to accomplish the tasks described herein is termed a system. Where otherwise not specifically defined, acronyms are given their ordinary meaning in the art.

The instructions for implementing processes or methods of the system, may be provided on computer-readable storage media or memories, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instruction set, storage media, processor or processing strategy and may be performed by software, hardware, integrated circuits, firmware, micro code and the like, operating alone or in combination. Likewise, processing strategies may include multiprocessing, multitasking, parallel processing and the like.

In an embodiment, the instructions may be stored on a removable media device for reading by local or remote systems. In other embodiments, the instructions may stored in a remote location for transfer through a computer network, a local or wide area network or over telephone lines. In yet other embodiments, the instructions are stored within a specified computer or system.

The instructions may be a computer program product, stored or distributed on computer readable media, containing some or all of the instructions to be executed on a computer to perform all or a portion of the method or the operation of the system.

Medical data systems and medical procedures may be used collect information on patients, including medical history, demographic information, results of medical tests, prior treatment, including specific worksteps and outcomes, and other information related to individual patients. Generally, the course of treatment, or care path for a patient may be based an electronic formula or other algorithm, which may be deterministic or probabilistic, with the detailed course of treatment based on the symptoms, tests and patient response to treatment. The course of treatment may be termed a “care path” or a “care plan”. Each medical facility may have different suites of treatment and diagnostic equipments, and constraints on the use thereof due to scheduling conflicts.

As advanced methods for self-learning and prediction, the system could use artificial neural networks, genetic algorithms, Bayesian methods, estimation theory, fuzzy logic, and the like. The system may learn about the user preferences for performing certain examination procedures and may optimize the user interface accordingly. The system may offer default protocols for performing examinations according to optimized care paths.

The present embodiments may provide a system/software application operable to accept data from a form-based input device, and to retrieve data from a data base having medical history of the patient. The software application may include a user interface that implements access rights or other security measures. The user interface may provide user at one facility with access to data associated with the patient and the care plan collected at other facilities.

In an aspect, the system and method may include using a form-based entry of symptoms, and related medical data and diagnoses, a rule-based engine, an interface with a care plan implementation system, a data base, and input and output mechanisms. The diagnosis method may be implemented and programmed in an electronic formula or other algorithm. The fields in the formula may be linked to a database, either remote or local, such as a Microsoft SQL-database with a SQL (Structured Query Language) server. Other databases may be used. The system may be operable to add, delete, and/or select data (such as text and/or images) from data files. The system may offer a search mechanism, such as a search engine, operable to search remote databases. For instance, medical personnel at one facility may be able to remotely search a database stored at another facility involved with the performance of the diagnosis and subsequent care plan to gather information about the patient, tests and diagnoses which may be related to the present syndrome and which have previously been performed performed, and other information regarding the patient, including patient characteristics and other healthcare data provided to the patient and which may be unrelated to the care plan (such as medications previously or currently prescribed for the patient and past illnesses treated).

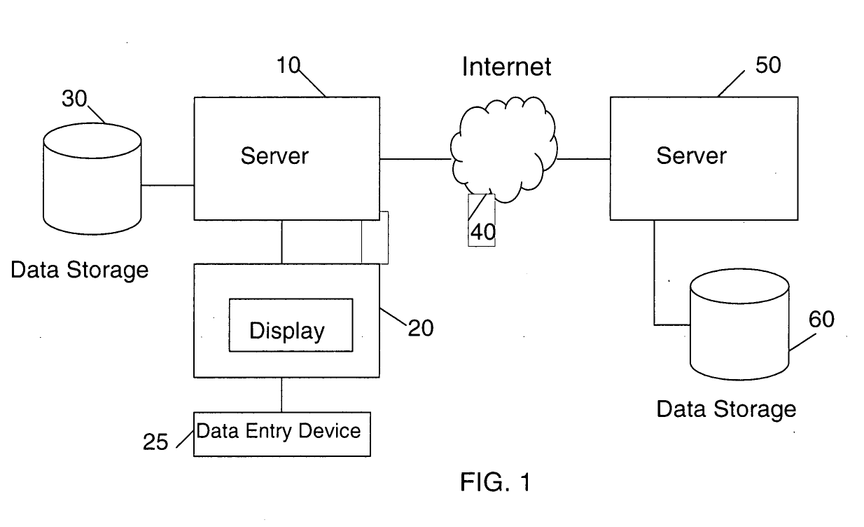

FIG. 1 is an example of a computing system architecture which may be suitable for executing the software programs and managing the data bases associated with the diagnosis and care processes. A server or computer 10 may execute a software product so as to exhibit the functionality described herein, where the server is a computing device having a central processor unit (CPU), memory and interfaces, as is known in the art, and an attached memory system which may be, for example, semiconductor memory, a rotating disk 30, magnetic tape, or a combination thereof. Such memories may be local to the server 10, and be connected through interfaces or a local area network (LAN). In an aspect, the data may be located at another facility and accessed through a wide area network (WAN), which may be the Internet 40, or other telecommunication system. Typically, at least portions of the WAN are provided by others, and the LAN may be an existing shared resource at the local medical facility. The remotely located data base may be stored on a disk 60, or other non-volatile or backed-up volatile memory attached to a server 50 having an interface to the WAN.

Forms may be displayed on a display unit 20, which may be located in the emergency room, an ambulance, or other location convenient to the professional responding with the information solicited by the form. The information may be entered through a keyboard 25, keypad, touch screen or by voice recognition, depending on the location of the data entry device.

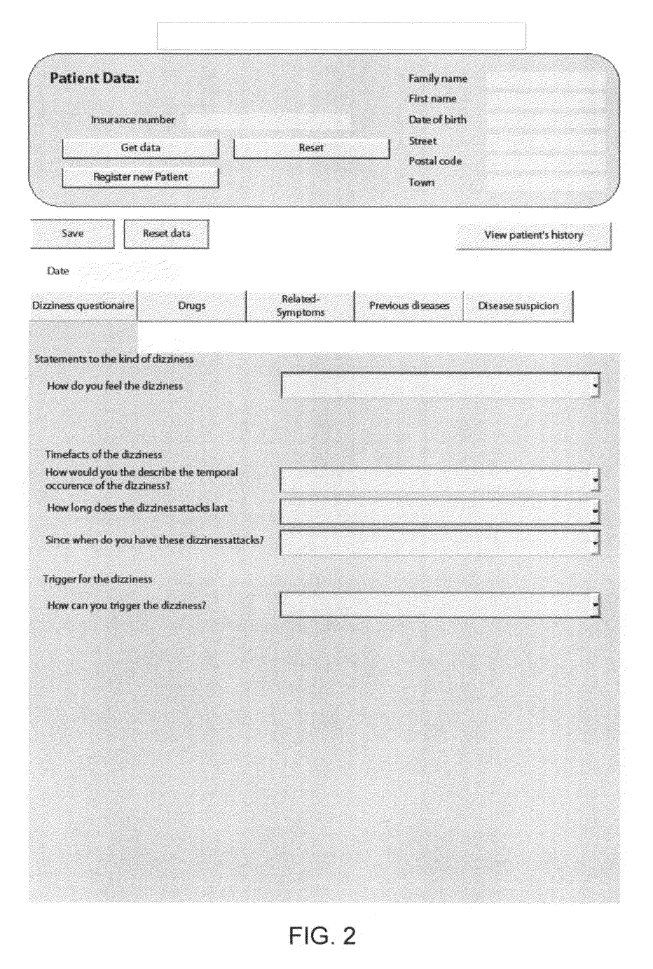

In an example, FIG. 2 shows an example of a questionnaire-type input form intended to structure the input data so as to facilitate the use a rule-based diagnosis engine. The rule-based engine may have deterministic or probabilistic characteristics, and contain heuristic decision rules based on a “best practices” diagnosis procedure. The procedure may have been adapted to local needs, as the personnel and diagnostic equipment suite may differ. Even at a specific facility, the availability of specific equipment and personnel may be time dependent.

The form shown is a representation of the type of entry form that may be displayed for the use of, for example, emergency room personnel where a neurological problem is suspected. This particular questionnaire may be used to retrieve information regarding a patient that may be stored at the medical facility. Where a networked system is deployed, such as described in U.S. patent application Ser. No. 11/796,524, filed on Apr. 27, 2007, entitled “Service Module in Clinical Workflow Simulation Tool for Healthcare Institutions,” which is commonly owned and which is incorporated herein by reference, the stored information may be accessed where permitted and as relevant to the present situation. This may be done, for example, by entering the patient's name, an insurance or other identifying number, date of birth, or the like. Access to the patient data may be controlled by password or other means, including biometric data, as is known in the art, or may later be developed.

The patient history accessed may be recent or historical, depending on the situation. To the extent that information can be obtained from the patient or other person, a dizziness questionnaire, as shown, may be completed. This is structured so as to obtain information in a simple form that is associated with the diagnostic process. In this example, much of the information may be entered through drop-down boxes; however, radio buttons, check boxes and the like are similarly useful. In this example, the patient's perception of the effect of dizziness, the temporal characteristics of the dizziness, and any precipitating factors are explored.

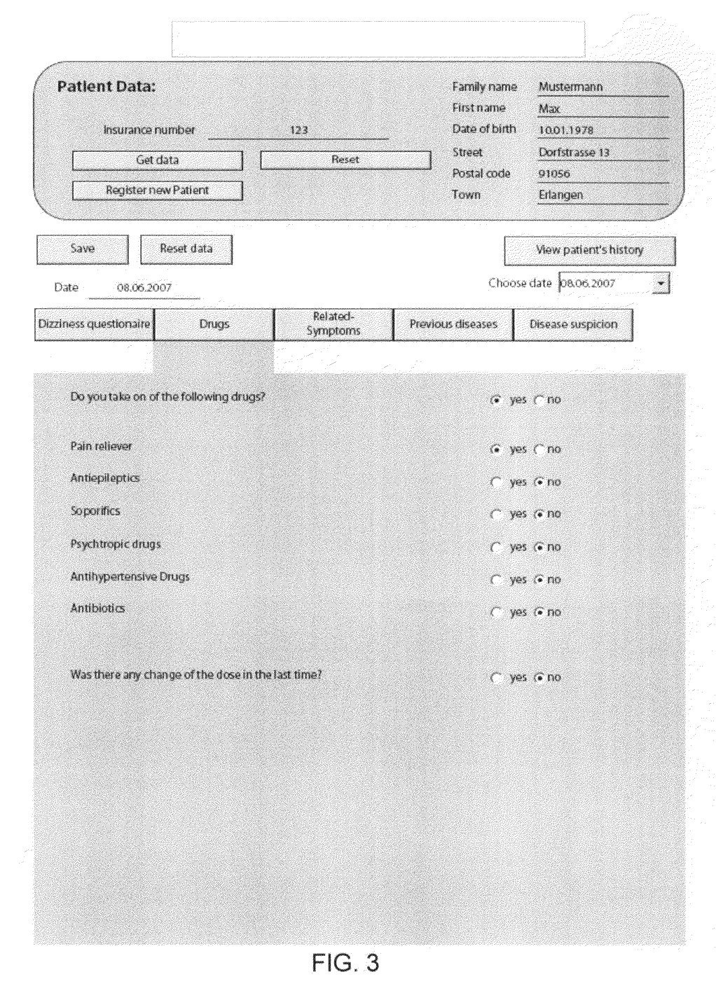

Continuing with the information gathering, FIG. 3 shows the form for collecting information about drugs currently being taken by the patient, by category. A “Yes” answer may result in a request for information relating to the specific drug being taken, as many drugs are known to have side-effects and interactions which may be relevant to the diagnosis. Dizziness or disorientation may be as side-effect of a drug, rather than a stroke, for example. Other medical conditions are likewise known to result in dizziness or stroke-like symptoms. Many of the drugs are specific to a prior diagnosis, and that information may also be useable.

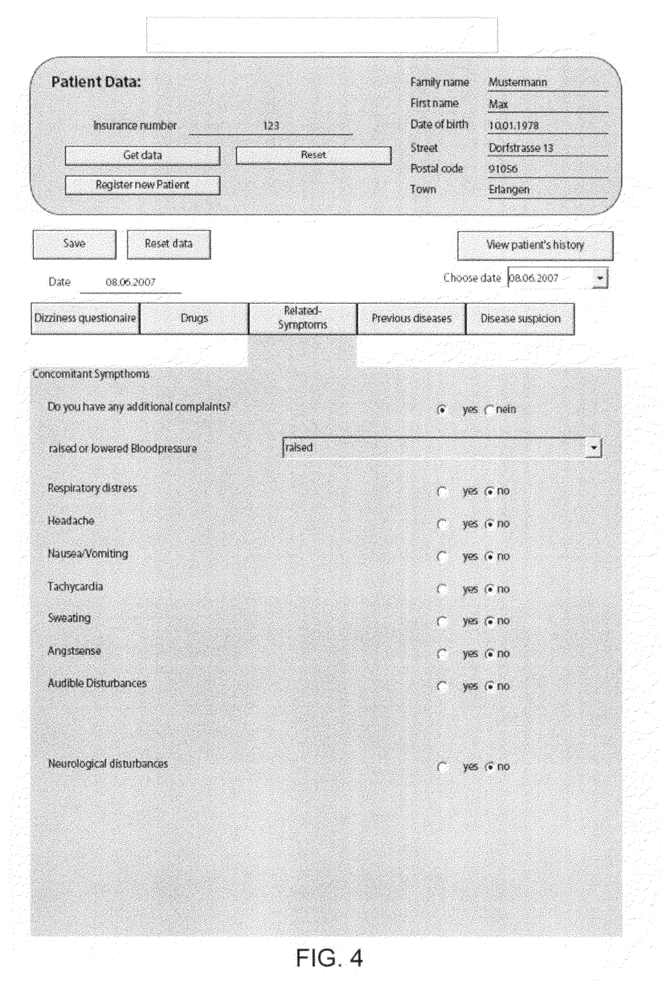

Further, FIG. 4 shows entries related to a constellation of symptoms that may be observed by the emergency room personnel, or be reported by the patient, including headache, sweating, anxiety, blood pressure, pulse rate, and the like. Another questionnaire page, not shown, may relate to previous diseases and may be filled out by interview or supplemented by data obtainable for the data base of patient records.

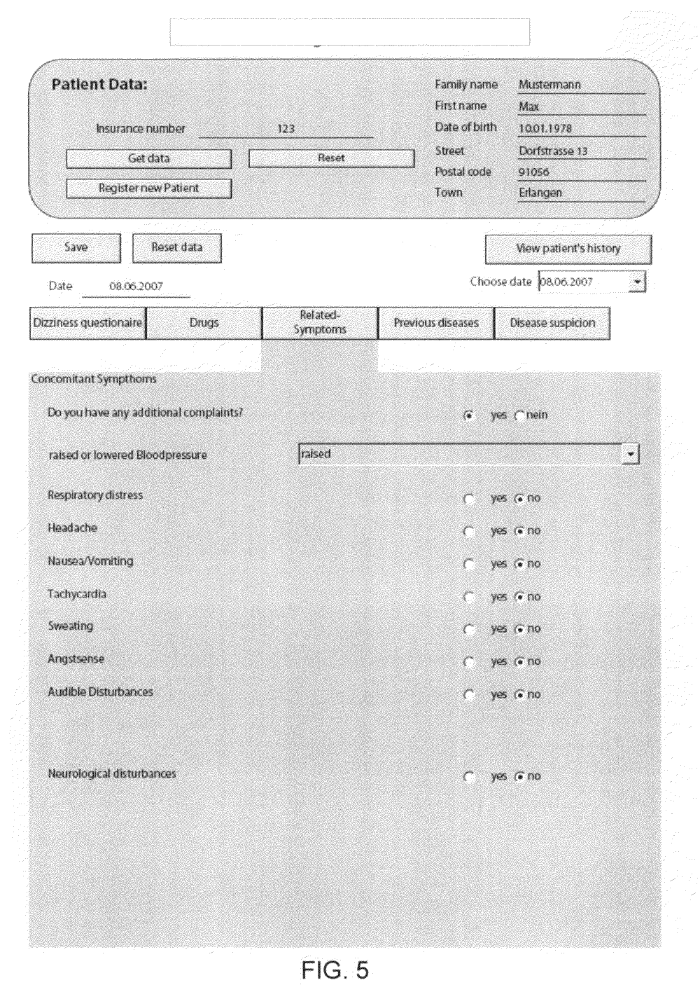

The results of the rule-based analysis of the data input to the questionnaires as well as any patient history data may be processed by the rule-based engine, and a suggested diagnosis and care path displayed, as in FIG. 5.

While the description has been in terms of the data gathering and data input by emergency room personnel, this type of data may equally be obtained by an input by, for example, emergency medical technicians (EMT) who are accompanying the patient to the hospital or other treatment facility in an ambulance or emergency vehicle. The vehicle may be in radio contact by voice or data with the treatment facility, and be able to access patient medical information, or at least complete portions of the questionnaire in transit. As such the emergency room personnel may already have the results shown in FIG. 5, and may be better able to schedule any further diagnostic or confirmatory tests needed by the care plan protocol.

A example of a diagnosis method and an analysis of the data associated with the diagnosis has been described; however, this approach may be adapted to a specific facility, and evolve with time as medical knowledge advances.

The methods disclosed herein have been described and shown with reference to particular steps performed in a particular order; however, it will be understood that these steps may be combined, sub-divided, or reordered to from an equivalent method without departing from the teachings of the present invention. Accordingly, unless specifically indicated herein, the order and grouping of steps is not a limitation of the present invention.

While the preferred embodiments of the invention have been described, it should be understood that the invention is not so limited and modifications may be made without departing from the invention. The scope of the invention is defined by the appended claims, and all systems and methods and products that come within the meaning of the claims, either literally or by equivalence, are intended to be embraced therein.

What is claimed is:

1. A method of diagnosing a neurological syndrome of a patient, the method comprising:
providing a plurality of computer-displayable data forms, at least one of which provides for a selection of multiple responses to each of a plurality of pre-determined questions;
linking the forms to a data base of the patient medical history data, and retrieving data that is available for the patient;
displaying requested data of the available patient medical history; and
providing a rule-based engine to process at least one of responses entered on the forms, or information from the data base, so as to provide at least a preliminary diagnosis of the syndrome and a recommended care path,
wherein the rule-based engine is adapted to conform to the existing diagnostic procedures at a medical facility.

2. The method of claim 1, wherein recommended confirmatory diagnostic tests are displayed.

3. The method of claim 1, wherein at least a portion of the information needed for the form is entered while the patient is in transit to the medical facility.

4. The method of claim 1, wherein results of medical procedures currently or previously performed are linked to the forms.

5. The method of claim 1, wherein the data associated with responses to the questions of the forms is stored in the patient medical history data base.

6. The method of claim 1, wherein the result of the preliminary diagnosis is at one of ischemic stroke, or any other diagnosis.

7. The method of claim 1, wherein the result of the preliminary diagnosis is to rule out, or to recommend a test to rule out, a hemorrhagic stroke.

8. The method of claim 1, wherein information regarding the performance of specific medical diagnostic tests or procedures is displayed based on the response data entered in the data form.

9. The method of claim 1, wherein the forms are displayed on an electronic display, and the data is entered at least in part by a keyboard device.

10. A data processing system for diagnosing neurological syndromes, the system comprising:
a data processor operable to:
maintain a forms based data entry device, and a rule-based engine for analyzing data entered on the forms or retrieved from a patient medical history data base;
accept data from at least one of the form-based data entry device or the patient medical history data; and
analyze the data using the rule-based engine to determine a diagnosis, the diagnosis being one of: ischemic stroke, hemorrhagic stroke, or other syndrome, where the other syndrome is not associated with stroke,
wherein the rule-based engine is adapted to conform to diagnostic procedures and decision criteria of a local medical facility.

11. The data processing system of claim 10, wherein the patient medical history data base is accessed through a telecommunications network.

12. The data processing system of claim 11, wherein the telecommunications network is the Internet.

13. The data base system of claim 10, wherein the data processor receives data input from the form-based data entry device, at least in part over a wireless network.

14. A computer-readable medium having instructions executable on a computer stored thereon, the instructions causing a computer system to:
store and maintain a form-based data entry procedure;
access at least one of a patient history data base, or a care plan protocol;
accept data input to a form or retrieve patient history data;
process at least one of the form or retrieved data using a rule-based engine; and
select a diagnosis consistent with the data,
wherein the rule-based engine is adapted to conform to the diagnostic procedures and decision criteria of a local medical facility.

15. The computer readable medium of claim 14, wherein the diagnosis is one of: ischemic stroke, hemorrhagic stroke, or other syndrome not associated with stroke.

16. The computer readable medium of claim 14, wherein the data input to the form is transmitted to the computer system, at least in part, over a wireless communications link.

17. The computer readable medium of claim 14, wherein:
a care path is chosen and displayed, consistent with the diagnosis.
